(19) United States
(12) Patent Application Publication
(10) Pub. No.: US 2013/0271691 A1
(43) Pub. Date: Oct. 17, 2013

(54) Backlight Module and LCD Device

(71) Applicant: Yajun Yu, Shenzhen (CN)

(72) Inventor: Yajun Yu, Shenzhen (CN)

(21) Appl. No.: 13/509,727

(22) PCT Filed: Apr. 16, 2012
(86) PCT No.: PCT/CN12/74075

§ 371 Date: May 14, 2012

(30) Foreign Application Priority Data
Apr. 11, 2012 (CN) 201210103938.7

(51) Int. Cl. G09F 13/04; G02F 1/13357

(52) U.S. Cl. 349/58; 362/612

(57) ABSTRACT

The invention provides a backlight module and an LCD device. The backlight module includes a backplane, a middle frame, a light source, and an LGP optically coupled with the light source; the backplane, the middle frame and the LGP form a long and narrow cavity on the light incident side inside the backlight module, and the light source is arranged in the cavity; the long and narrow cavity wall of the cavity is provided with air vents which enable convection to be formed between the air inside the cavity and the air outside the cavity. In the invention, because the cavity wall of the cavity formed by the backplane, the middle frame and the LGP inside the backlight module around the lightbar is provided with air vents extending to the outside of the backlight module, convection is formed between the air with higher temperature inside the cavity and the air with lower temperature outside the cavity by the air vents. Thus, heat exchange is conducted between the heat in the cavity of the backlight module and the outside air in time, and the temperature in the cavity of the backlight module and the temperature of the cavity wall are reduced.

### TECHNICAL FIELD

The invention relates to the field of liquid crystal displays (LCDs), and more particularly to a backlight module and an LCD device.

### BACKGROUND

As a key component of an LCD device, a backlight module is mainly used for providing sufficient brightness and uniformly distributed light sources, to enable an LCD panel to normally display images.

FIG. 1 shows a backlight module of an LCD device, including a backplane 100, a light emitting diode (LED) lightbar 140 fixed on the side wall of the backplane 100, a reflecting plate 110 arranged on the backplane 100, a light guide panel (LGP) 120 which is arranged on the reflecting plate 110 and opposite to the LED lightbar 140, a middle frame 150 and an outer frame 200 which are arranged outside the backplane 100 and used for pressing the LGP 120; optical film(s) 130 is arranged on the light emitting surface of the LGP 120, and an LCD panel 300 is fixed above the backlight module by components including the middle frame 150, the outer frame 200 and the like. The LED lightbar 140 of such structure is fixed on the backplane 100. In an inner cavity of the backlight module, the heat emitted by the LED lightbar 140 is conducted to the surface of the backplane 100 by the side wall of the backplane 100, and then is dissipated by air convection. However, because the heat conduction path is long, the heat is accumulated in the inner cavity of the backlight module for a long time, resulting in high temperature of the inner cavity for a long time, and causing certain damage to the components in the backlight module; thus, the components such as the reflecting plate 110, the LGP 120 and the like in the backlight module operate in an area of accumulated heat for a long time and then change, reducing the display effect of the LCD device.

As shown in FIG. 2, U.S. Pat. Pub. No. US2010/0002418A1 discloses another backlight module, including a backplane 100, a heat conducting plate 190 closely attached to the backplane 100, an LED lightbar 140 fixed on the side wall of the backplane 100, an LGP 120 arranged opposite to LED(s) 142 of the LED lightbar 140, a reflecting plate 110 arranged below the LGP 120, and an outer frame 200 arranged outside the backplane 100; optical film(s) 130 is arranged on the light emitting surface of the LGP 120, and an LCD panel 300 is arranged above the backlight module. In addition, the backlight module further includes a support piece 170 which is used for supporting the components including the reflecting plate 110, the LGP 120 thereon and the like, and then a gap 180 is formed between the heat conducting plate 190 and the reflecting plate 110, to play a role of heat insulation. However, although the influence of the heat on the reflecting plate 110, etc. is avoided during heat transfer as far as possible in the arranging mode, the heat conduction path remains that: heat is conducted to the backplane 100 by the heat conducting plate 190, and is dissipated by the contact between the backplane 100 and air. Because the heat dissipation path is long, heat is accumulated in the inner cavity of the backlight module for a long time, thereby resulting in high temperature in the backlight module for a long time, and then affecting the safety of the components in the backlight module.

### SUMMARY

In view of the above-described problems, the aim of the invention is to provide a backlight module with good heat dissipation effect and an LCD device.

The aim of the invention is achieved by the following technical scheme.

A backlight module comprises a backplane, a middle frame, a light source, and an LGP optically coupled with the light source; the backplane, the middle frame and the LGP form a long and narrow cavity on the light incident side inside the backlight module, and the light source is arranged in the cavity. The long and narrow cavity wall of the cavity is provided with one or more rows of air vents, and the air vents of each row are arranged in the cavity wall in the extending direction of the cavity. A separator used for separating the cavity into a heat conducting zone and a lighting zone is further arranged in the cavity, the separator is provided with openings, an LED lightbar is used as the light source, LEDs of the LED lightbar are arranged in the openings, a printed circuit board (PCB) of the LED lightbar is positioned in the heat conducting zone, and the air vents are arranged in the cavity wall of the heat conducting zone of the cavity.

The aim of the invention is further achieved by another technical scheme. A backlight module comprises a backplane, a middle frame, a light source, and an LGP optically coupled with the light source; the backplane, the middle frame and the LGP form a long and narrow cavity on the light incident side inside the backlight module, and the light source is arranged in the cavity. The long and narrow cavity wall of the cavity is provided with air vents which enable convection to be formed between the air inside the cavity and the air outside the cavity.

Preferably, a separator used for separating the cavity into a heat conducting zone and a lighting zone is further arranged in the cavity, the separator is provided with openings, the LED lightbar is used as the light source, the LEDs of the LED lightbar are arranged in the openings, the PCB of the LED lightbar is positioned in the heat conducting zone, and the air vents are arranged in the cavity wall of the heat conducting zone of the cavity.

Preferably, the separator is of a plastic structure. The separator of plastic structure has good heat insulation performance.

Preferably, the separator is of a metal structure. The separator of metal structure has good light reflection performance.

Preferably, the air vents comprise one or more rows of air vents arranged in the cavity wall of the cavity, and the air vents of each row are arranged in the cavity wall in the extending direction of the cavity. Thus, air is cyclically flowed from bottom to top in the cavity, and then the heat dissipation efficiency is increased.

Preferably, the air vents comprise one or more rows of back air vents arranged in a bottom panel of the backplane, and the back air vents of each row are arranged in the cavity wall in the extending direction of the cavity. Because the air vent are arranged in the bottom panel of the backplane, and the back of the backplane of the LCD device is protected by a back frame, the outside dust is prevented from entering the cavity as far as possible.

Preferably, the backlight module comprises an outer frame; the air vents comprise one or more rows of side air vents arranged in the outer frame, and the side air vents of each row are arranged in the cavity wall in the extending direction of the cavity. The side wall of the middle frame and the side wall of the backplane are provided with corresponding openings or receiving structures corresponding to the side air vents to enable the side air vents to be communicated with the cavity. Thus, the heat dissipation efficiency is increased, and overmuch heat can be prevented from being conducted to the LCD panel by the middle frame and the outer frame.

Preferably, the air vents comprise air inlet holes arranged in the lower part of the cavity wall of the cavity, and air outlet holes arranged in the upper part of the cavity wall of the cavity. Because only the upper part and the lower part of the cavity are provided with the air inlet holes and air outlet holes, the number of openings arranged in the backlight module is reduced, and the strength of the components such as the backplane, the outer frame and the like is improved.

Preferably, the backlight module comprises an outer frame; the upper part of the cavity is provided with a plurality of air outlet holes which are arranged side by side, and the air outlet holes are arranged in the outer frame; the lower part of the cavity is provided with a plurality of air inlet holes which are arranged side by side, and the air inlet holes are arranged in the bottom panel of the backplane. Because the air inlet holes and the air outlet holes are respectively arranged in different components, the strength of the components is prevented from being reduced.

An LCD device comprises a backlight module mentioned above.

In the invention, because the cavity wall of the cavity formed by the backplane, the middle frame and the LGP in the backlight module around the lightbar is provided with air vents extending to the outside of the backlight module, convection is formed between the air with higher temperature inside the cavity and the air with lower temperature outside the cavity by the air vents. Thus, heat is taken out of the cavity by the air in the backlight module in time, and the outside air with lower temperature enters the cavity by the air vents to conduct heat exchange with the heat of the cavity wall of the cavity and then is discharged by the air vents. Therefore, the heat in the cavity of the backlight module is dissipated by the convection air in time, and the temperature in the cavity of the backlight module and the temperature of the cavity wall are reduced. The cavity wall is the components for forming the cavity, comprising the backplane, the middle frame, the LGP, the PCB arranged in the cavity, etc.

### BRIEF DESCRIPTION OF FIGURES

FIG. 1 is a simplified structure diagram of one conventional backlight module;

FIG. 2 is a simplified structure diagram of another conventional backlight module;

FIG. 3 is one simplified structure diagram of a liquid crystal display module of a first example of the invention;

FIG. 4 is one simplified structure diagram of a liquid crystal display module of a first example of the invention;

FIG. 5 is another simplified structure diagram of a liquid crystal display module of a first example of the invention;

FIG. 6 is a simplified structure diagram of a liquid crystal display module of a second example of the invention;

FIG. 7 is a simplified structure diagram of a separator of a first example and a second example of the invention;

FIG. 8 is a first simplified structure diagram of a middle frame of a first example of the invention;

FIG. 9 is a second simplified structure diagram of a middle frame of a first example of the invention; and

FIG. 10 is a third simplified structure diagram of a middle frame of a first example of the invention.

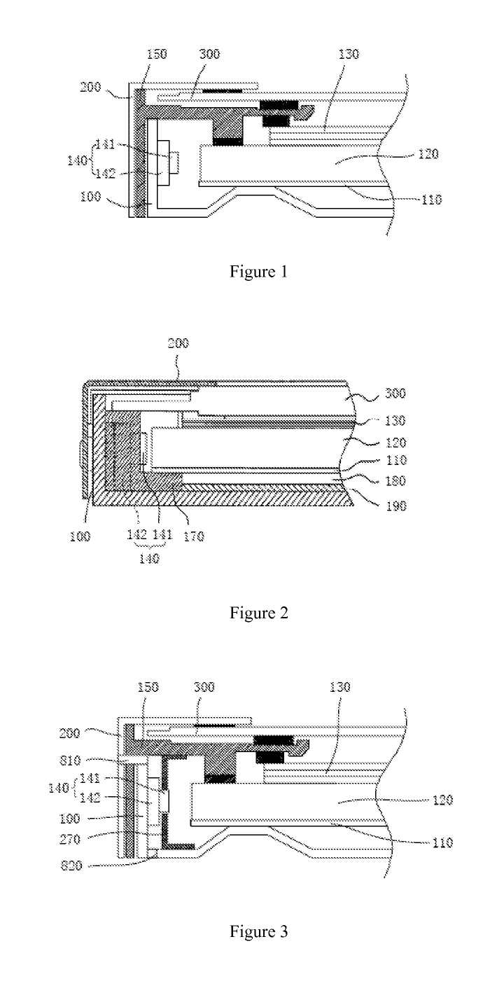

Legends: 100. backplane; 110. Reflecting plate; 120. LGP; 130. optical film; 140. LED lightbar; 150. middle frame; 170. support piece; 180. gap; 190. heat conducting plate; 141. LED; 142. PCB; 270. separator; 810. side air vent; 820. back air vent; 830. air outlet hole; 840. air inlet hole.

### DETAILED DESCRIPTION

The invention will further be described in detail in accordance with the figures and the preferred examples.

FIGS. 3-6 show a backlight module of an LCD device of the invention, comprising a backplane 100, a reflecting plate 110 arranged on the backplane 100, an LED lightbar 140 arranged on the side wall of the backplane 100, an LGP 120 which is arranged on the reflecting plate 110 and opposite to the LED lightbar 140, and a middle frame 150 and an outer frame 200 which are arranged outside the backplane 100 and used for pressing the LGP 120; optical film(s) 130 is arranged on the light emitting surface of the LGP 120, and an LCD panel 300 is fixed above the backlight module by components comprising the middle frame 150, the outer frame 200 and the like; the LGP 120, the middle frame 150 and the backplane 100 form a long and narrow cavity for the LED lightbar 140 on the light incident side inside the backlight module, and the LED lightbar 140 used as a light source is arranged in the cavity. The long and narrow cavity wall of the cavity is provided with air vents extending to the outside of the backlight module, and the air vents are arranged in the cavity wall in the extending direction of the cavity, to enable convection to be formed between the air inside the cavity and the air outside the cavity. The cavity wall is the components for forming the long and narrow cavity, comprising the backplane, the middle frame, the LGP, the PCB arranged in the cavity, the outer frame, etc.

### EXAMPLE 1

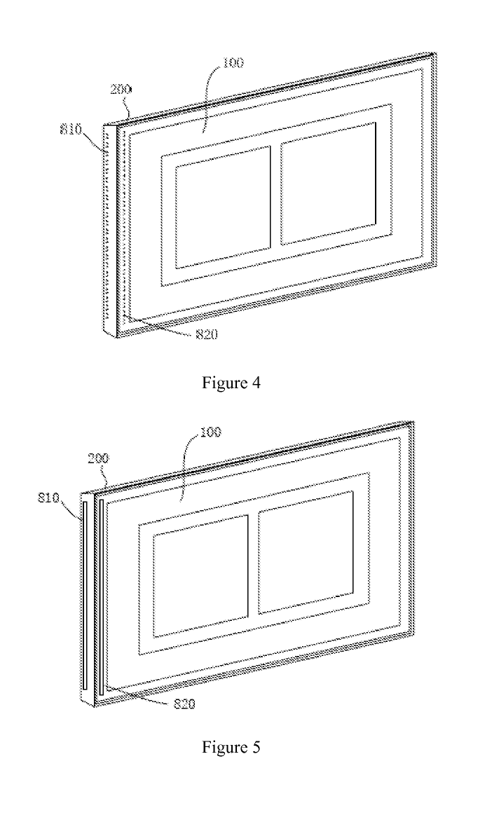

As shown in FIG. 3 and FIG. 4, the long and narrow cavity wall of the cavity of the backlight module formed by the LGP 120, the middle frame 150 and the backplane 100 inside the backlight module is provided with two rows of air vents. Optionally, the air vents can be one or more rows of air vents. As shown in FIG. 4, the air vents are respectively two rows of air vents arranged in the backplane 100 and the outer frame 200 from bottom to top: side air vents 810 and back air vents 820. The back air vents 820 arranged in the bottom panel of the backplane 100 directly lead to the cavity, and the side air vents 810 arranged in the outer frame 200 require that the side wall of the middle frame 150 and the side wall of the backplane 100 are provided with openings or receiving structures to enable the side air vents 810 to be communicated with the cavity. As shown in FIG. 4, the side air vents 810 and the back air vents 820 are arranged in the LCD device from bottom to top, namely arranged from the lower end to the upper end of the cavity. Thus, when the LCD device operates, the LEDs 141 of the LED lightbar 140 emit heat, thereby rising the temperature of the air inside the cavity and the temperature of the cavity wall (comprising the backplane, the PCB, the middle frame, the LGP, etc.). Air is from the side air vents 810 or the back air vents 820 because air expands when heated. The air of the lower part of the cavity rises when heated and is discharged from the side air vents 810 or the back air vents 820 which are arranged in the upper part because the pressure inside the cavity is reduced, and air is supplemented to the lower part of the cavity by the side air vents 810 or the back air vents 820 which are arranged in the lower part because of pressure difference, thereby forming the circulating convection of the air in the cavity. Therefore, the temperature of the air inside the cavity is reduced, and the temperature of the components including the backplane 100, the PCB 142, the middle frame 150, etc. is reduced by conducting heat exchange to the components using air circulation flow. In addition, because a heat insulation band is formed by the side air vents 810 and the back air vents 820 on the middle frame 150 and the outer frame 200, the heat of the backplane 100 is conducted to the LCD panel 300 by the middle frame and the outer frame as few as possible, and then the temperature is prevented from rising to affect the LCD panel.

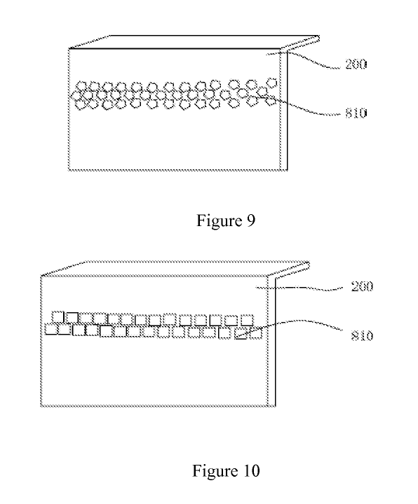

FIGS. 8-10 show the outer frame 200 of the example and side air vents 810 arranged therein. The side air vents 810 can be one row, two rows, three rows, or even more rows of holes which are arranged or crosswise arranged, and the shape of the air vents 810 can be any shape such as square, round, polygon, etc. Optionally, the back air vents 820 can be made into similar structure as well.

In addition, as shown in FIG. 5, in the first example, the side air vents 810 and the back air vents 820 can be two long and thin notches directly arranged in the outer frame and the backplane, and each notch is equivalent to one row of side air vents or one row of back air vents, which facilities processing.

### EXAMPLE 2

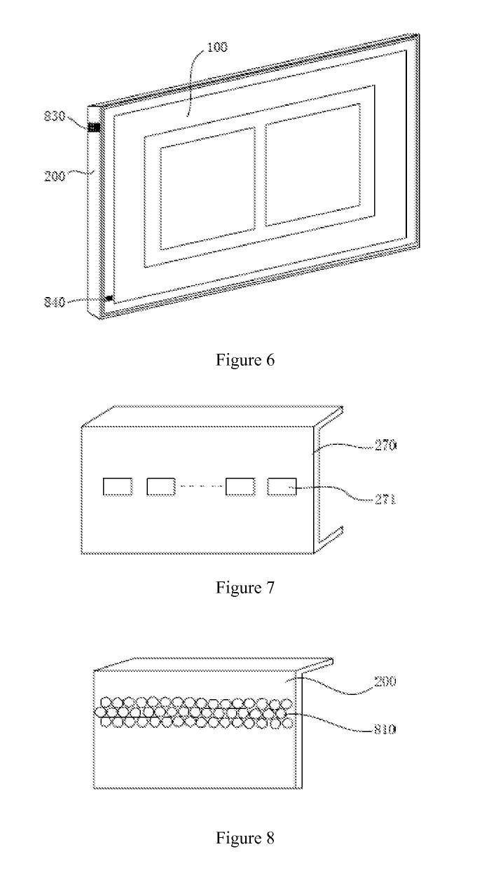

As shown in FIG. 6, the cavity wall of the cavity of the backlight module formed by the LGP, the middle frame and the backplane 100 inside the backlight module is provided with a plurality of air vents; the air vents are respectively air inlet holes 840 which are positioned in the lower part of the cavity wall of the cavity, and air outlet holes 830 which are positioned in the upper part of the cavity wall of the cavity. The PCB 142 of the LED lightbar 140 is arranged on the side wall of the backplane 100 in the cavity. Thus, when the LCD device operates, the LEDs 141 of the LED lightbar 140 emit heat, thereby rising the temperature of air inside the cavity and the temperature of the cavity wall (comprising the backplane, the PCB, the middle frame, the LGP, etc.) . Air is discharged from the air outlet holes 830 because air expands when heated, and the air of the lower part enters the cavity from the air inlet holes to form circulation because the pressure inside the cavity is reduced. Thus, flowing air is formed in the cavity, and then the temperature of the air inside the cavity is reduced. Meanwhile, the temperature of the components comprising the backplane 100, the PCB 142, the middle frame 150, etc. is reduced by conducting heat exchange to the components using air circulation flow.

In the second example of the invention, the air inlet holes 840 which are positioned in the lower part are arranged in the bottom panel of the backplane 100, the air outlet holes 830 which are positioned in the upper part are arranged in the side wall of the outer frame 150, and the air outlet holes 810 are formed by arranging openings in the corresponding positions of the backplane 100, the middle frame 150 and the outer frame 200. The air inlet holes 840 and the air outlet holes 830 can be a plurality of small air vents which are arranged, thereby preventing dust from entering the cavity; or the air inlet holes 840 and the air outlet holes 830 can be a big vent, and the big vent hole is provided with a layer of dust screen, to prevent dust from entering the cavity.

Furthermore, as shown in FIG. 3, in the first example and the second example of the invention, a separator 270 used for separating the cavity into a heat conducting zone and a lighting zone is further arranged in the cavity formed by the LGP 120, the middle frame 150 and the backplane 100 inside the backlight module. As shown in FIG. 7, the separator 270 is provided with openings 271, the LEDs of the LED lightbar 140 are arranged in the openings 271, the PCB 142 of the LED lightbar 140 is positioned in the heat conducting zone, and the air vents are arranged in the cavity wall of the heat conducting zone of the cavity. The separator 270 can be made of plastic material with good heat insulation performance or metal material with good light reflection performance, and can also be made of composite material as long as no light is leaked. One side of the separator 270 is fixed to the middle frame 150 by contact, and the other side is fixed to the bottom surface of the backplane 100 by contact. The fixing mode can be common mode such as using adhesive, etc., thereby preventing dust from entering the lighting zone to pollute the LGP and the LEDs and affect the display quality, and further preventing the problem of light leakage.

For the two examples of the invention, the LED lightbar is used as the light source of the backlight module. Optionally, the technical scheme of the invention is also applied to other light sources of emitting heat, such as cold cathode fluorescent lamps (CCFLs), etc.

Finally, what deserves to be mentioned is that: the air vents can be arranged in the cavity top or cavity bottom of the cavity in addition to being arranged in the long and narrow cavity wall of the cavity. However, if the air vents are arranged in the cavity top, dust is easy to enter the cavity by the air vents. In addition, because the volume of the cavity is not large, and the number of the air vents arranged in the cavity top and the cavity bottom is few, the speed of air circulation and flow is low and the volume of the flowing air is less. Thus, the heat dissipation effect is poor.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A backlight module, comprising: a backplane, a middle frame, a light source, and an LGP optically coupled with said light source; wherein said backplane, said middle frame and said LGP form a long and narrow cavity on the light incident side inside said backlight module, and said light source is arranged in said cavity; the long and narrow cavity wall of said cavity is provided with one or more row(s) of air vents, and said air vents of each row are arranged in said cavity wall in the extending direction of said cavity; a separator used for separating said cavity into a heat conducting zone and a lighting zone is further arranged in said cavity, said separator is provided with openings, an LED lightbar is used as said light source, LEDs of said LED lightbar are arranged in said openings, a PCB of said LED lightbar is positioned in said heat conducting zone, and said air vents are arranged in the cavity wall of the heat conducting zone of said cavity.

2. A backlight module, comprising: a backplane, a middle frame, a light source, and an LGP optically coupled with said light source; wherein said backplane, said middle frame and said LGP form a long and narrow cavity on the light incident side inside said backlight module, and said light source is arranged in said cavity; the long and narrow cavity wall of said cavity is provided with air vents which enable convection to be formed between the air inside said cavity and the air outside said cavity.

3. The backlight module of claim 2, wherein a separator used for separating said cavity into a heat conducting zone and a lighting zone is further arranged in said cavity, said separator is provided with openings, an LED lightbar is used as said light source, LEDs of said LED lightbar are arranged in said openings, a PCB of said LED lightbar is positioned in said heat conducting zone, and said air vents are arranged in the cavity wall of the heat conducting zone of said cavity.

4. The backlight module of claim 3, wherein said separator is of a plastic structure.

5. The backlight module of claim 3, wherein said separator is of a metal structure.

6. The backlight module of claim 2, wherein said air vents comprise one or more rows of air vents arranged in the cavity wall of said cavity, and said air vents of each row are arranged in said cavity wall in the extending direction of said cavity.

7. The backlight module of claim 6, wherein said air vents comprise one or more rows of back air vents arranged in the bottom panel of said backplane, and said back air vent of each row are arranged in said cavity wall in the extending direction of said cavity.

8. The backlight module of claim 6, wherein said backlight module comprises an outer frame; said air vents comprise one or more rows of side air vents arranged in said outer frame, and said side air vents of each row are arranged in said cavity wall in the extending direction of said cavity; the side wall of said middle frame and the side wall of said backplane are provided with corresponding openings or receiving structures corresponding to said side air vents to enable said side air vents to be communicated with said cavity.

9. The backlight module of claim 2, wherein said air vents comprise air inlet holes arranged in the lower part of the cavity wall of said cavity, and air outlet holes arranged in the upper part of the cavity wall of said cavity.

10. The backlight module of claim 9, wherein said backlight module comprises an outer frame; the upper part of said cavity is provided with a plurality of air outlet holes, and said air outlet holes are arranged in said outer frame; the lower part of said cavity is provided with a plurality of air inlet holes, and said air inlet holes are arranged in the bottom panel of said backplane.

11. An LCD device, comprising: a backplane, a middle frame, a light source, and an LGP optically coupled with said light source; wherein said backplane, said middle frame and said LGP form a long and narrow cavity on the light incident side inside said backlight module, and said light source is arranged in said cavity; the long and narrow cavity wall of said cavity is provided with air vents which enable convection to be formed between the air inside said cavity and the air outside said cavity.

12. The LCD device of claim 11, wherein a separator used for separating said cavity into a heat conducting zone and a lighting zone is further arranged in said cavity, said separator is provided with openings, an LED lightbar is used as said light source, LEDs of said LED lightbar are arranged in said openings, a PCB of said LED lightbar is positioned in said heat conducting zone, and said air vents are arranged in the cavity wall of the heat conducting zone of said cavity.

13. The LCD device of claim 12, wherein said separator is of a plastic structure.

14. The LCD device of claim 12, wherein said separator is of a metal structure.

15. The LCD device of claim 11, wherein said air vents comprise one or more rows of air vents arranged in the cavity wall of said cavity, and said air vents of each row are arranged in said cavity wall in the extending direction of said cavity.

16. The LCD device of claim 15, wherein said air vents comprise one or more rows of back air vents arranged in the bottom panel of said backplane, and said back air vents of each row are arranged in said cavity wall in the extending direction of said cavity.

17. The LCD device of claim 15, wherein said backlight module comprises an outer frame; said air vents comprise one or more rows of side air vents arranged in said outer frame, and said side air vents of each row are arranged in said cavity wall in the extending direction of said cavity; the side wall of said middle frame and the side wall of said backplane are provided with corresponding openings or receiving structures corresponding to said side air vents to enable the side air vents to be communicated with said cavity.

18. The LCD device of claim 11, wherein said air vents comprise air inlet holes arranged in the lower part of the cavity wall of said cavity, and air outlet holes arranged in the upper part of the cavity wall of said cavity.

19. The LCD device of claim 18, wherein said backlight module comprises an outer frame; the upper part of said cavity is provided with a plurality of air outlet holes, and said air outlet holes are arranged in said outer frame; the lower part of said cavity is provided with a plurality of air inlet holes, and said air inlet holes are arranged in the bottom panel of said backplane.
